(19) United States
(12) Patent Application Publication
(10) Pub. No.: US 2017/0078540 A1
(43) Pub. Date: Mar. 16, 2017

(54) Camera for Recording Image Data From a Detection Zone

(71) Applicant: SICK AG, Waldkirch/Breisgau (DE)

(72) Inventors: Florian SCHNEIDER, Reute (DE); Dirk STROHMEIER, Freiburg (DE)

(21) Appl. No.: 15/253,996

(22) Filed: Sep. 1, 2016

(30) Foreign Application Priority Data
Sep. 2, 2015 (EP) 15183477.7

(51) Int. Cl. H04N 5/225; G02B 27/28; H04N 5/372

(52) U.S. Cl. CPC H04N 5/2254; H04N 5/372; G02B 27/286

(57) ABSTRACT

The invention comprises a camera having an image sensor for recording image data from a detection zone, having two optically effective elements which are configured and arranged such that they direct light from the detection zone along two different optical paths onto two different regions of the image sensor, wherein a respective filter is located in the different optical paths and the transmission properties of the filters of the different optical paths differ with respect to at least one predefined physical property of the transmitted light.

The invention relates to a camera having an image sensor for recording image data from a detection zone.

2D and 3D cameras are in particular used in an industrial environment for the identification, inspection and measurement of objects. Such cameras have an image sensor onto which an image of a scene is as a rule imaged via a detection optics. The image sensor, which can be a CCD sensor, for example, forwards the image data to an evaluation unit which further processes the recorded image, for example via image processing algorithms.

Objects on a conveyor belt can be identified, counted or distinguished in this manner, for example.

It can in particular be difficult with problematic surface properties such as glossy or multicolor surfaces, for example, to discriminate the article from its environment in order, for example, to be able to detect its shape or presence. There can also be problems with articles which only differ slightly from the background.

It is desirable in this respect to find further possibilities for distinguishing. For this purpose, for example, polarization filters or color filters are used in the reception path in order only to examine a specific polarization property or only a specific color.

It is the object of the present invention to provide an improved camera with which it is possible to identify, inspect or measure objects in a simple and reliable manner.

This object is satisfied by a camera having the features of claim 1 and by a camera having the features of claim 9. Dependent claims are directed to preferred embodiments.

A camera in accordance with the invention in accordance with claim 1 has two optically effective elements which are configured and arranged such that they direct light from the detection zone along two different optical paths onto two different regions of the image sensor. Two images of the imaged scene are therefore produced on the image sensor. An object located in the detection zone is therefore imaged twice on the image sensor.

A respective filter is located in the different optical paths which are produced with the aid of the two optically effective elements. The filters of the different optical paths differ in their transmission properties with respect to at least one predefined physical property of the transmitted light.

It is possible in this manner to present two images of the scene simultaneously on the image sensor, wherein the light used for producing the respective images on the image sensor has different properties.

In a preferred embodiment, the at least one predefined physical property of the transmitted light with respect to which the filters differ comprises the polarization. With such an embodiment, a polarization filter of a first polarization direction is therefore included in the one optical path, for example, whereas a polarization filter of a different polarization direction is present in the other optical path. The images on the image sensor produced of the one scene in this manner therefore differ in that the light producing them has a different polarization. It can in this respect be a question of different linear and/or different circular and/or different elliptical polarizations. The fact can, for example, in particular be utilized in this manner with objects which reflect in a specular manner and/or with an oblique incidence of light that one polarization direction is preferably reflected on the reflection and is in this respect represented clearly or differently on the image sensor than with the light of a different polarization direction.

In another, alternative or additional, preferred embodiment, the filters differ in their spectral properties. It is possible in this manner to record a scene in two different colors simultaneously. It can be ensured in this manner, without the color of an object to be detected having to be known beforehand, for example, that a color is imaged in isolation which can be seen better than if no color discrimination were to take place.

The two images of the scene detected on the image sensor can be combined to form one total piece of information with the aid of image processing systems, which piece of information allows a much better identification, detection or measurement of objects in the scene, for example.

In a particularly advantageous embodiment, the two regions of the image sensor are arranged next to one another on the image sensor. It is in particular possible in this manner with scenes which are much more extensive in one dimension than in the other dimension to utilize a substantially symmetrical (that is, for example, square) image sensor better or completely since the two elongated images can be arranged next to one another on the image sensor.

A further development provides that not only two optically effective elements are provided, but rather more than two such optically effective elements which image light from the detection zone along a corresponding number of optical paths onto a corresponding number of regions on the image sensor. Filters which differ with respect to a physical property are provided in the individual optical paths so that the light incident onto the different regions of the image sensor differs with respect to a physical property. Color filters of three or more different spectral ranges can thus be provided, for example, or polarization filters which transmit differently polarized light (linearly polarized light and/or circularly polarized light perpendicular to one another, etc.) and which image it into different regions on the image sensor.

A particularly simple and advantageous embodiment of the camera in accordance with the invention provides that the optically effective elements comprise mirrors which are mutually tilted in a first direction. It can be achieved with the aid of this tilt that the optical paths are directed to the different regions of the image sensor.

A simple and symmetrical arrangement provides in this respect that two mutually tilted mirrors are provided which deflect the light from the detection zone by the same amount, but in different directions.

A versatile embodiment provides that the mirrors, in addition to their mutually directed tilt, are also inclined in a second direction relative to one another which is perpendicular to the direction of the mutual tilt of the mirrors. It is possible in this manner also to use the camera in accordance with the invention additionally to image different spatial zones of a scene. It is, for example, possible with such an embodiment that a first part of the scene is imaged by a first mirror and a second part of the scene is imaged by a second mirror. The two part regions imaged in this manner can overlap in part, for example, such that—as described above—light from this overlap zone is deflected through different optical paths such that different filters can be used. Additional information can nevertheless still be acquired in the non-overlapping part regions which additional information is then, however, only respectively directed through one optical path, but can nevertheless provide an additional identification aid or measurement aid, for example of an object present in the scene.

It is additionally possible that the mutually tilted mirrors are arranged overall such that they effect a deflection of the optical path by approximately 45°, for example, to be able to give the camera a more compact design, for example, or to be able to match it better to the given demands.

In another embodiment of the camera in accordance with the invention, it is not mirrors that are provided as optically effective elements, but rather optical prisms which have a different direction of refraction and which can in this respect also be used for deflecting the light from the detection zone along two or more optical paths.

A further embodiment of the camera in accordance with the invention in accordance with claim 9 provides that only one mirror is provided which can, however, be tilted with the aid of a tilting unit between at least one first and one second tilt position such that it directs light from the detection zone along at least two different optical paths onto different regions of the image sensor. As described above, filters are in turn present in these different optical paths whose transmission properties differ with respect to at least one predefined physical property of the transmitted light. It is, for example, possible with such an embodiment to switch the light from the detection zone “to and fro” between the two optical paths such that first the one region of the image sensor (onto which the light is incident through the one filter) is illuminated and then the other region of the image sensor (onto which the light is incident through the other filter) is illuminated alternately in time. A comparable effect such as is described above for an embodiment using two or more mirrors can then be achieved, for example, using an evaluation of the image sensor synchronized correspondingly in time.

A particularly practical embodiment of the camera in accordance with the invention provides that the optically effective elements are mounted in a housing which represents a releasable part of the camera. It is possible in this manner, depending on the demand or on the available construction space, to swap correspondingly dimensioned and configured housings having optically effective elements present therein with one another in order ideally to take account of the respective circumstances.

Such a releasable housing makes it possible in a simple manner in the sense of modular design to allow an adaptation to different construction spaces or geometrical circumstances in that housings having different optically effective elements (mirrors and/or deflection prisms) in different arrangements can be kept at hand which can be connected to the remaining part of the camera.

The invention will be explained in detail with reference to the enclosed Figures. There are shown in a schematic representation:

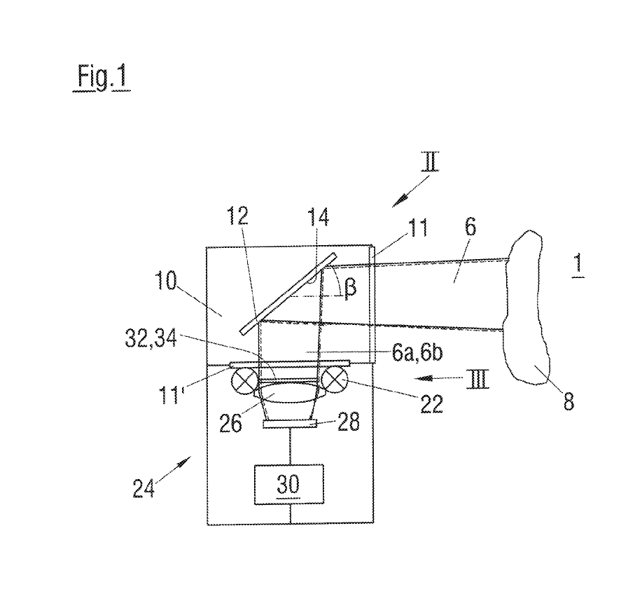

FIG. 1 a lateral sectional view of an embodiment in accordance with the invention with two mirrors;

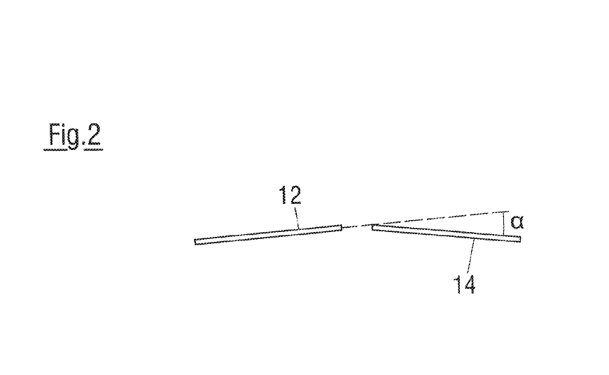

FIG. 2 a detailed view in the direction of view of FIG. 1 marked by II;

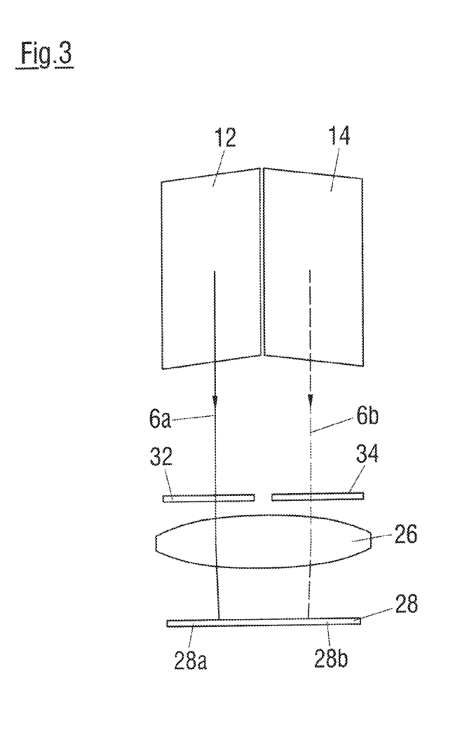

FIG. 3 a lateral sectional view in the direction of view marked by III in FIG. 1;

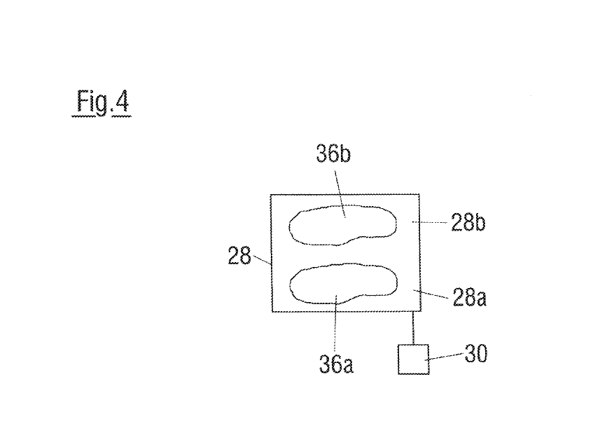

FIG. 4 an image sensor with images of an object shown by way of example thereon:

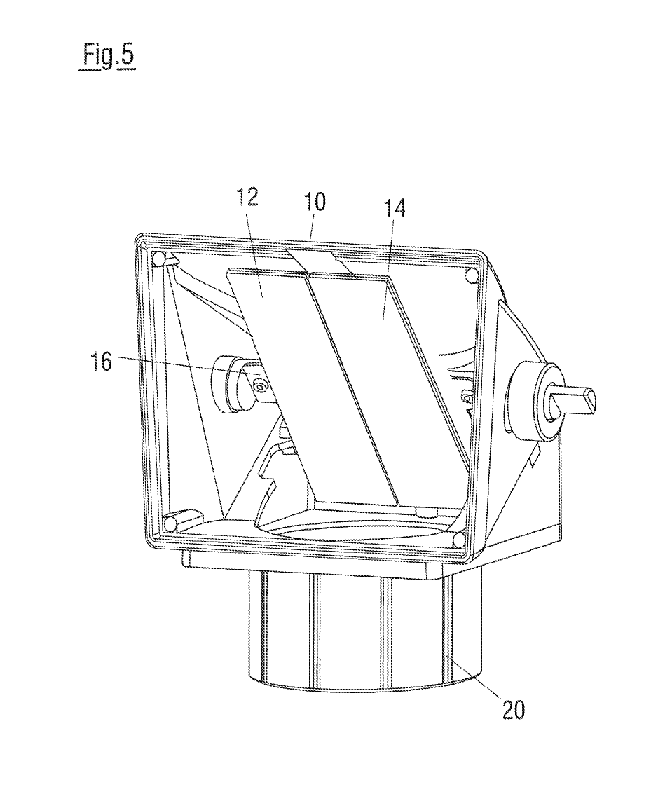

FIG. 5 an embodiment of a part of a camera in accordance with the invention with the optically effective elements in a perspective representation;

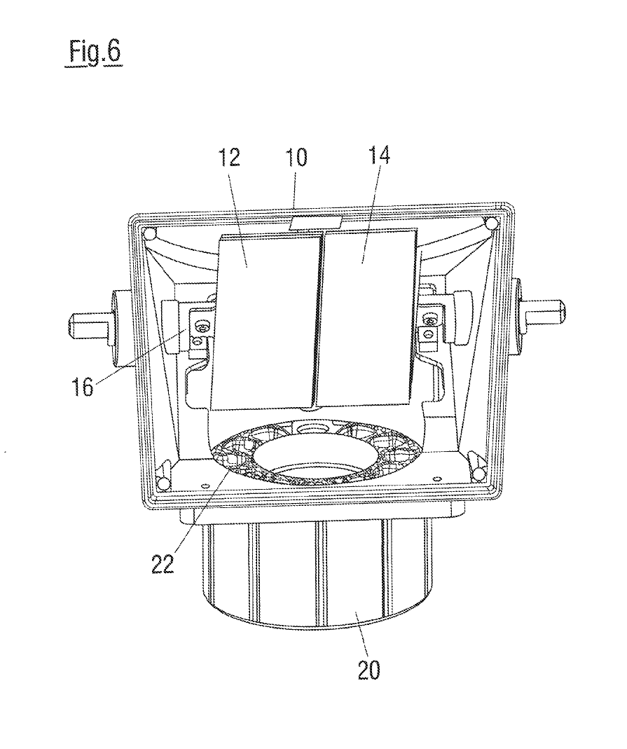

FIG. 6 the part of the camera shown in FIG. 5 in a plan view from the front;

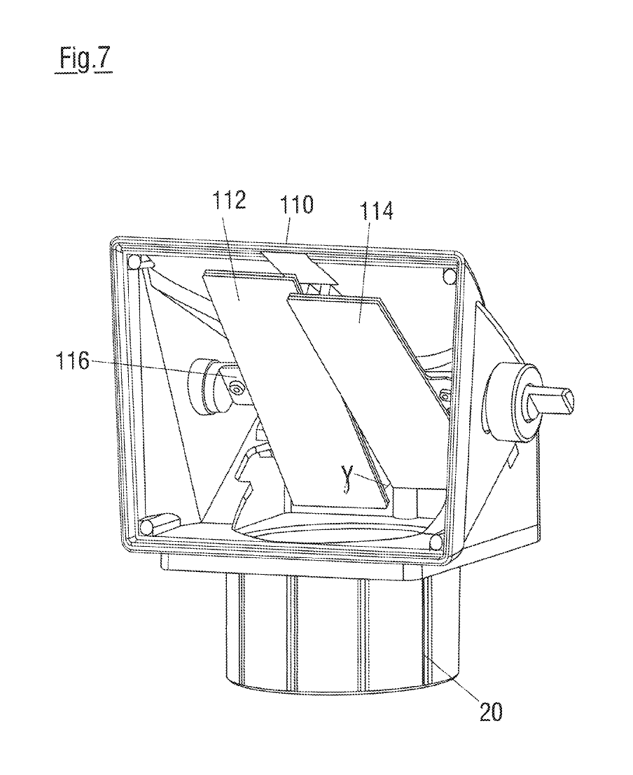

FIG. 7 a different embodiment with an additional inclination of the mirror elements with respect to one another;

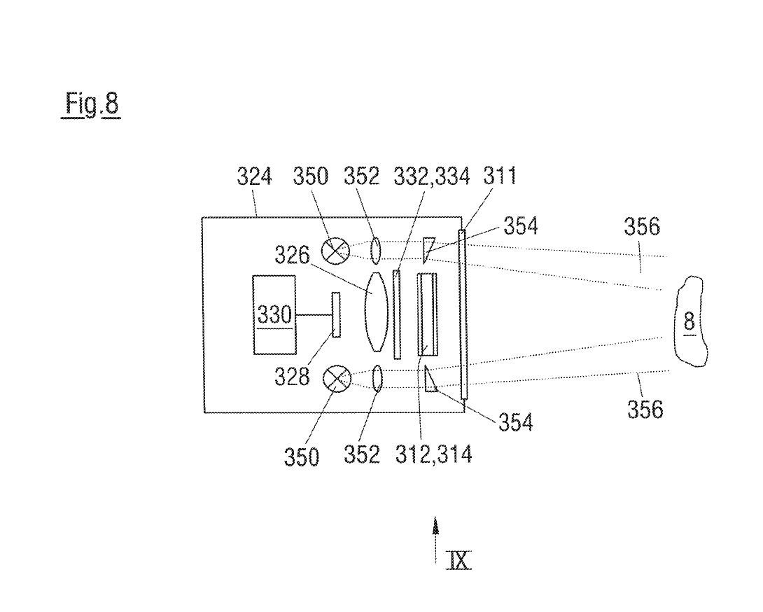

FIG. 8 a sectional view of a different embodiment in accordance with the invention with optical prisms as optically effective elements; and

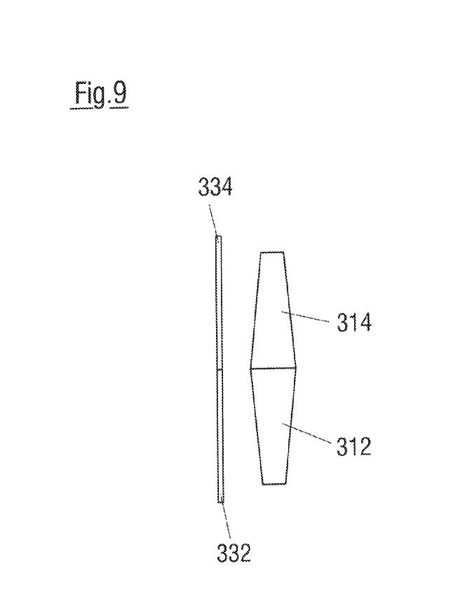

FIG. 9 a detailed view of the embodiment shown in FIG. 8 in the direction of view IX marked therein.

FIG. 1 shows a camera 24 in accordance with the invention in a lateral section in a schematic representation. An object 8 is, for example, located in the detection zone 1. Light 6 from the detection zone 1 is incident onto mirrors 12, 14 which are arranged behind one another in the representation of FIG. 1 and whose spatial arrangement with respect to one another will be explained in detail with respect to the following Figures.

The light 6 is, for example, incident into the housing 10 through an inlet window 11. It is deflected by approximately 90° by the mirrors 12, 14. This deflection of the light from the detection zone by approximately 90° is achieved in that the mirrors 12, 14 are inclined in the manner shown in FIG. 1 by an angle β of approximately 45° with respect to the optical paths or with respect to the optical axle of the camera.

Since the mirrors 12, 14 are additionally tilted with respect to one another, which cannot be recognized in the representation of FIG. 1, the light is deflected along two optical paths 6a and 6b. The arrangement of the mirrors 12, 14 can be recognized better in FIG. 2 which provides a detailed view of the mirror arrangement in the direction of view II of FIG. 1. It can be recognized here that the mirrors 12, 14 are tilted with respect to one another by an angle α to direct the light incident onto them along two different optical paths. The mutual tilting of the mirrors 12, 14 in the arrangement shown in FIG. 2 is, however, so small (e.g. only a few degrees) that it is cannot be recognized in the schematic representation of FIG. 1.

The optical paths 6a, 6b along which the mirrors 12 and 14 direct the incident light 6 are disposed behind one another in FIG. 1 and can in this respect likewise not be illustrated separately in FIG. 1. This is schematically indicated in that the boundary lines of the optical paths are shown as solid for the one optical path 6a and as dashed for the other optical path 6b. In the view of FIG. 1, these optical paths are, however, behind one another and can accordingly actually not be distinguished in FIG. 1.

The light of the optical paths 6a, 6b deflected in this manner exits the housing 10 through a further window 11′ into a further housing. It transilluminates optical filters 32, 34 which are likewise arranged behind one another in FIG. 1. In this respect, the optical path 6a is incident onto the optical filter 32 and the optical path 6b is incident onto the optical filter 34 which is behind the optical filter 32 in the illustration of FIG. 1. The optical filters 32, 34 differ, for example, in the direction of polarization or in the manner of the circular polarization of the light transmitted by them. It is thus possible, for example, that the optical filters 32 and 34 comprise polarizers having linear polarization directions differing by 90°.

After passing through the polarizers 32, 34, the light is directed onto the image sensor 28 by a correspondingly large reception lens 26. As is also shown in the Figures, the filter arrangement 32, 34 can be located directly in front of the reception lens 26. The image sensor 28 can, for example, be a CCD (charge coupled device) element. The image sensor 28 produces electrical signals which are forwarded to an evaluation unit 30 and are evaluated in a manner still to be described. Light sources 22 are also shown in FIG. 1 which are arranged beneath the window 11° in the embodiment shown and which illuminate the detection zone 1 via the mirrors 12, 14. They can, for example, be a plurality of illumination sources (e.g. LEDs) arranged in circular form in this respect.

A view is shown in detail in FIG. 3 which corresponds to the direction of view III such as is indicated in FIG. 1. The mutually tilted mirrors 12, 14 can be seen here whose tilt angle α (FIG. 2) is so small that it is also hardly to be recognized in FIG. 3.

The optical paths 6a and 6b into which the incident light 6 is directed by this tilt of the mirrors 12, 14 is only shown schematically. The optical path 6a is incident through the optical filter 32, while the optical path 6b is incident through the optical filter 34. The sufficiently largely dimensioned received light lens 26 directs the light onto the image sensor 28. As described, the filters 32, 34 differ by the direction of polarization of the light they transmit. A different arrangement of the optical paths can also be present depending on the magnitude of the angle α and on the spacings of the elements in the camera. A crossover of the optical paths can e.g.

thus be implemented such that light reflected by the mirror 14 is incident onto the part region 28a of the image sensor through the filter 32 and light reflected by the mirror 12 is incident onto the part region 28b of the image sensor through the filter 34.

The two part regions 28a and 28b of the image sensor can be recognized in FIG. 3 which are arranged next to one another on the image sensor 28 and which in each case take up approximately half the image sensor 28 in the embodiment shown. Light of only one polarization is imaged on the one part region 28a of the image sensor 28, whereas light polarized in a different polarization direction is received by the other part region 28b of the image sensor 28. This is achieved by the different polarization filters 32, 34 in the optical paths 6a, 6b.

A plan view of the image sensor 28 fro he perspective of the reception lens 26 can be seen for this purpose in FIG. 4.

FIG. 5 shows a perspective representation of a specific embodiment of the upper part of the camera. The mirrors 12, 13 can be recognized here which are mutually tilted (FIG. 2) by an angle α not shown or hardly recognizable in FIG. 5. In addition, both mirrors are fastened to an axle 16 which enables the mirrors to be inclined by approximately 45° (see FIG. 1, angle β) against the beam direction to deflect the beam by approximately 90°. The housing 10 in this embodiment is configured such that it has a nose 20 by which it can be fastened to a further housing element in which the image sensor 28, the reception lens 26, the illumination unit 22 and the evaluation unit 30 are located.

FIG. 6 shows a plan view of the housing 10 shown perspectively in FIG. 5. The illumination light sources 22 can additionally be recognized here.

The described embodiment works as follows.

Light 6 from the detection zone 1 from which in particular the object 8 is to be imaged is incident into the housing 10 and onto the mirrors 12, 14 attached there. It is connected articulated by approximately 90° and is simultaneously directed along the two optical paths 6a and 6b by the mutual tilt of the mirrors 12, 14 by the angle α. The different optical paths 6a, 6b are polarized in different directions by the polarization filters 32, 34. The light is directed onto the image sensor 28 by the reception lens 26. Two images 36a and 36b of the object 8 arise on said image sensor, as can be seen in FIG. 4. The image 36a on the first part region 28a of the image sensor 28 is produced in this respect by light of the one polarization, while the image 36b in the second part region 28b of the image sensor 28 is produced by light of the polarization perpendicular thereto. These polarization directions are caused by the polarizers 32, 34.

The signal of the image sensor 28 is evaluated with the aid of the evaluation unit 30. In this respect, the information of the two images 36a and 36b is evaluated by suitable image processing to be able to determine the information on, for example, the position and the size of the object 8 in two different manners. If it is, for example, an object reflecting in a specular manner, the different polarization direction of light with which the part images 36a and 36b are produced can produce a contrast of different levels. It is therefore ensured in every case due to the evaluation of the different polarization directions that this additional information can also be utilized without having to consider the specular properties of the object.

FIG. 7 shows a representation corresponding to FIG. 5 of a further developed embodiment of the housing 110. Here, the mirrors 112, 114 are mutually inclined, in addition to the mutual tilt by the angle α (FIG. 2), by an angle γ in a further direction perpendicular with respect to the direction of tilt. This inclination accordingly corresponds to a different inclination of the mirrors 112, 114 about the axle 116. It is possible in this manner also to use the element to observe different spatial part regions of the detection zone 1. The different part regions are then evaluated through the filters 32, 34 having different polarization properties of the transmitted light. Provision can be made in this respect, for example, that the individual part regions of the scene recorded from the detection zone 1 via the mirrors 112, 114 overlap in part. This overlap region is evaluated in different manners through the different polarizers 32, 34.

However, due to the mutual inclination of the mirrors 112, 114, there are also outer regions of the detection zone 1 which are only directed by one of the mirrors in the direction of the image sensor. This extension of the visible zone can then only be observed in one polarization direction. Additional information can nevertheless be acquired here which can be used, for example, for measuring the object. In the overlap region, in contrast, the different polarizations can nevertheless be evaluated—as described.

The different visible zones are imaged onto different part regions of the image sensor 28 by the mutual tilting of the mirrors 112, 114 by the angle α. The angle α by which the mirrors 112 112 are mutually tilted (see the above description with respect to the embodiment of FIGS. 1 to 6, in particular FIG. 2) is also not shown in FIG. 7. This tilt by the angle α is in the direction perpendicular to the mutual inclination by the angle γ.

In an embodiment not shown, two mirrors 12, 14; 112, 114 are not provided, but rather only one mirror which can be tilted with the aid of a corresponding tilting unit between two positions which differ by the tilt angle α. It is possible in this manner to direct the light from the detection zone to the one or the other part region 28a, 28b of the image sensor 28 in dependence on the position of the tilting unit. If the tilting unit is operated periodically, for example, an alternating illumination of the part regions 28a, 28b of the image sensor can be achieved in this manner, wherein the optical paths effective for this purpose are deflected by the filter 32, on the one hand, and by the filter 34, on the other hand, such that the images on the image sensor 28 differ in the part regions 28a and 28b by the polarization direction the light incident thereon has. In this respect, a similar function can be achieved using such as arrangement as with an arrangement of FIGS. 1 to 6.

The present text as a rule speaks of “inclination” when the inclination of the mirrors 12, 14; 112, 114 about an axle 16, 116 is meant (angles β, γ). “Tilt” is in contrast used as a rule for a mutual tilt of the mirrors 12, 14; 112, 114 about an axle perpendicular thereto (angle α).

FIG. 8 shows another embodiment of a camera 324 in accordance with the invention. An object 8 is in general also imaged from a detection zone 1 here. The optical path of the corresponding light is not shown in FIG. 8 for reasons of clarity. The light is incident into the camera 324 through an inlet window 311. It is there incident onto two optically effective elements 312, 314 which here comprise optical prisms. These optical prisms 312, 314 appear as is shown in FIG. 9 in the direction of view IX of FIG. 8. It can be recognized here that the prisms 312, 314 have different directions of refraction. It additionally becomes clear that the different prisms 312, 314 lie behind one another in the perspective of FIG. 8 such that they cannot be shown separately there. The light is incident onto the filters 322, 334 through the optical prisms 312, 314 (FIG. 8). These filters are also arranged behind one another in the perspective of FIG. 8 so that they cannot be individually recognized. It can be recognized in the view of FIG. 9 that the filters 332, 334 are arranged next to one another.

The filters 332, 334 are in turn optical filters of different directions of polarization. The light is incident through the filters onto the reception lens 326 from where it is directed in the direction of the image sensor 328. The signal of the image sensor 328, which can likewise in turn be a CCD, is evaluated in the described manner by the evaluation unit 330 which in this respect corresponds to the evaluation unit 30 described with respect to the embodiments of FIGS. 1 to 7.

The image sensor 328 also corresponds to the already described image sensor 28 so that reference can be made to the above statements, in particular also with respect to FIG. 4. As already stated, the optical path of the imaging light from the object 8 up to the image sensor 328 is not shown for reasons of clarity in FIG. 8. However, light sources 350 are shown which correspond to the light sources 22 of the above-described embodiment. In the example shown, the light is directed through corresponding lenses 352 and deflection prisms 354 in the direction of the detection zone, as is explicitly shown in FIG. 8. Illumination light 356 is produced in this manner with which the object 8 is irradiated.

An effect is ensured by the different direction of refraction of deflection prisms 312, 314 which is achieved in the embodiment of FIGS. 1 to 7 by the mutual tilt of the mirrors 12, 14 by the angle α. The deflection prisms 312, 314 in this respect replace the function of the mirrors 12, 14. The deflection prisms 312, 314 or the illumination prisms 352 can consist of glass or plastic, for example. In the latter case, a simple manufacture is possible in an injection molding process, for example.

Possible chromatic aberration due to the wavelength-dependent refractive power of the prisms is not significant due to the small prismatic angles of only a few degrees.

In the same way as in the embodiments of FIGS. 1 to 7, it is possible to provide an embodiment of FIGS. 8 and 9 in a separate housing for the deflection prisms 312, 314.

It is generally also possible to arrange the deflection prisms 312, 314 (FIG. 9) or the mirrors 12, 14 (FIGS. 2 and 3) at a spacing from one another. A positioning as close as possible is, however, advantageous to be able to detect as much light as possible and to direct it to the image sensor 328, 28.

The described embodiments comprise polarization filters 32, 34 or 332, 334. Another embodiment does not use any polarization filters, but rather filters of different spectral transmission. It is possible in this manner only to transmit light of a specific wavelength range in the individual optical paths, wherein the transmitted wavelength ranges differ for the filters in the different optical paths. In the same way as described for the different polarization directions, it is then possible to produce images of the object 8 in different part regions 28a, 28b of the image sensor 28, 328 which correspond to different wavelengths. It is also possible in this manner to evaluate additional information which improves the detection, measurement and recording of an object.

### REFERENCE NUMERAL LIST

1 detection zone
6 optical path in the detection zone
6a, 6b deflected optical path
8 object
10 housing
11, 11′ window
12, 14 mirror
16 axle
20 nose
22 illumination light source
24 camera
26 reception lens
28 image sensor
28a, 28b part region of the image sensor
30 evaluation unit
32, 34 optical filter
36a image in the first part region of the image sensor
36b image in the second part region of the image sensor
110 housing
112, 114 mirror
116 axle
311, 11′ window
312, 314 deflection prism
324 camera
326 reception lens
328 image sensor
330 evaluation unit
332, 334 optical filter
350 illumination light source
352 lens
354 illumination light deflection prism
356 illumination light
α a mutual tilt angle between the mirrors
β angle of inclination of the mirrors with respect to the optical axle
γ mutual angle of inclination of the mirrors 112, 114 about the axle 116
II, III, IX direction of view

1. A camera having an image sensor for recording image data from a detection zone, having two optically effective elements which are configured and arranged such that they direct light from the detection zone along two different optical paths onto two different regions of the image sensor, wherein a respective filter is located in the different optical paths and transmission properties of the filters of the different optical paths differ with respect to at least one predefined physical property of the transmitted light.

2. The camera in accordance with claim 1, wherein the at least one predefined physical property of the transmitted light with respect to which the filters differ comprises a polarization.

3. The camera in accordance with claim 1, wherein the at least one predefined physical property of the transmitted light with respect to which the filters differ comprises a wavelength.

4. The camera in accordance with claim 1, wherein the optically effective elements comprise mirrors which are mutually tilted in a first direction by an angle.

5. The camera in accordance with claim 4, wherein the mirrors are mutually tilted such that they deflect the light from the detection zone by the same amount, but in different directions.

6. The camera in accordance with claim 4, wherein the mirrors are additionally inclined in a second direction with respect to the optical axle of the camera which is perpendicular to the direction of the mutual tilt of the mirrors.

7. The camera in accordance with claim 6, wherein the angle of inclination amounts to between 20° and 70°.

8. The camera in accordance with claim 6, wherein the angle of inclination amounts to between 40° to 50°.

9. The camera in accordance with claim 6, wherein the angle of inclination amounts to substantially 45°.

10. The camera in accordance with claim 1, wherein the optically effective elements comprise optical prisms of different directions of refraction.

11. The camera in accordance with claim 1, wherein more than two optically effective elements are provided which direct light from the detection zone onto different regions of the image sensor, with different filters being provided in the different optical paths produced by the optically effective elements.

12. The camera in accordance with claim 1, wherein the different regions of the image sensor lie next to one another.

13. The camera in accordance with claim 1, wherein the optically effective elements are mounted in a housing which represents a releasable part of the camera.

14. A camera having an image sensor for recording image data from a detection zone having a mirror and a tilting unit which can tilt the mirror between at least one first and one second tilt position such that it directs light from the detection zone along at least two different optical paths onto different regions of the image sensor, wherein a respective filter is located in the different optical paths and transmission properties of the filters of the different optical paths differ with respect to at least one predefined physical property of the transmitted light.

15. The camera in accordance with claim 14, wherein the at least one predefined physical property of the transmitted light with respect to which the filters differ comprises a polarization.

16. The camera in accordance with claim 14, wherein the at least one predefined physical property of the transmitted light with respect to which the filters differ comprises a wavelength.

17. The camera in accordance with claim 14, wherein the different regions of the image sensor lie next to one another.

18. The camera in accordance with claim 14, wherein the optically effective elements are mounted in a housing which represents a releasable part of the camera.
